(19) United States
(12) Patent Application Publication
(10) Pub. No.: US 2023/0177112 A1
(43) Pub. Date: Jun. 8, 2023

(54) METHOD AND SYSTEM FOR GENERATING A LOGICAL REPRESENTATION OF A DATA SET, AS WELL AS TRAINING METHOD

(71) Applicant: dSPACE GmbH, Paderborn (DE)

(72) Inventors: Thorsten PUESCHL, Paderborn (DE); Luka KARAMAN, Zagreb (HR); Vjekoslav DIKLIC, Zagreb (HR); Cathrina SOWA, Paderborn (DE)

(73) Assignee: dSPACE GmbH, Paderborn (DE)

(21) Appl. No.: 18/075,776

(22) Filed: Dec. 6, 2022

(30) Foreign Application Priority Data
Dec. 6, 2021 (EP) 21212420.0

(51) Int. Cl. G06F 18/213; G06F 18/2431; G06N 20/00

(52) U.S. Cl. CPC G06F 18/213; G06F 18/2431; G06N 20/00

(57) ABSTRACT

A method and system for generating a reduced complexity logical representation of a data set of sensor data, having a using of an algorithm on the second data set for reducing the complexity of the logical scenario, and an outputting of a third data set representing a reduced complexity logical scenario of the second data set. The invention additionally relates to a method for providing a trained machine learning algorithm for generating a reduced complexity representation of a data set of sensor data.

This nonprovisional application claims priority under 35 U.S.C. § 119(a) to European Patent Application No. 21212420.0, which was filed on Dec. 6, 2021, and which is herein incorporated by reference.

### BACKGROUND OF THE INVENTION

### Field of the Invention

The present invention relates to a method for generating a reduced complexity logical representation of a data set of sensor data.

The present invention relates to the method for providing a trained machine learning algorithm (A) for generating a reduced complexity representation of a data set of sensor data.

In addition, the present invention relates to a system for generating a reduced complexity logical representation of a data set of sensor data.

### Description of the Background Art

Driver assistance systems such as, e.g., adaptive cruise control and/or functions for highly automated driving, can be verified or validated with the aid of various testing methods. In particular, hardware-in-the-loop methods, software-in-the-loop methods, simulations, and/or test drives can be used in this context.

In order to create test scenarios for simulations, it is necessary for test drives to be performed. The sensor data obtained by this means are then abstracted into a logical scenario.

The paper “Szenario-Optimierung für die Absicherung von automatisierten and autonomen Fahrsystemen” [Scenario optimization for validation of automated and autonomous driving systems], (Florian Hauer, B. Holzmüller, 2019), discloses methods for the verification and validation of automated and autonomous driving systems, in particular the identification of suitable test scenarios for virtual validation.

The test methodology in this case provides for adaptation of a metaheuristic search in order to optimize scenarios. To this end, it is necessary for a suitable search space and an appropriate power function to be formulated. Starting from an abstract description of the functionality and application cases of the systems, parameterized scenarios are derived.

The parameters thereof span a search space from which the suitable scenarios are to be identified. To this end, search-based procedures are used that are oriented to a power function and thus identify the scenarios in which the system exhibits the worst behavior. The intent is to make possible goal-oriented testing with automatic test case analysis by this means.

In order to be able to use such a method optimally, however, it is necessary for the sensor data generated in test drives to be abstracted effectively into a logical scenario.

The difficulty here is to preserve the overall situation that is visible in the sensor data while at the same time making it possible to change variables in order to vary the scenario for generating new test cases for the simulation.

At a high level of abstraction, the problem exists here that initial settings of variable values do not accurately represent the situation of the data. Segmentation algorithms for generalizing the data have no information about the quality of the generated logical scenario (L).

This results either in a small number of data segments, with which an accuracy of the trajectories between the sensor data and the logical scenarios is not satisfactory, or in a large number of data segments, which is expressed in poor generalization and a greater number of parameters to be changed.

More parameters also lead to the problem that it is necessary to change more than one variable in order to change a scenario in a reasonable manner.

Accordingly, there is a need to improve existing methods for abstracting sensor data into logical scenarios such that the scenario contained in the sensor data can be preserved optimally with a smallest possible number of data segments.

### SUMMARY OF THE INVENTION

It is therefore an object of the present invention to provide a method for generating a reduced complexity logical representation of a data set of sensor data that permits a high degree of abstraction while at the same time optimally preserving the scenario contained in the sensor data.

The object is attained according to the invention by a method for generating a reduced complexity logical representation of a data set of sensor data. The object is further attained according to the invention by a method for providing a trained machine learning algorithm for generating a reduced complexity representation of a data set of sensor data. The object is further attained according to the invention by a system for generating a reduced complexity logical representation of a data set of sensor data.

The invention relates to a method for generating a reduced complexity logical representation of a data set of sensor data.

The method comprises a providing of a first data set of sensor data of a trip of an ego vehicle recorded by at least one on-board sensor. In general the term “ego vehicle” can represent a virtual vehicle in the center of a simulation or a test. E.g. the vehicle for that a new function is to be developed or tested. Typically, one skilled in the art uses such to distinguish a central vehicle (“ego”) from other vehicles or traffic participants (pedestrians, bicycles, etc.) that are usually called “fellows” or “fellow vehicles” that appear in a simulation or test and can interact or have an impact on the ego. For example, there may be several vehicles in a scenario in order to test a function of the ego vehicle but these fellow vehicles may not have the function to be tested (e.g. automatic braking systems.

The method additionally comprises a transforming of the first data set into a second data set having a multiplicity of classes of a logical scenario representing a vehicle action.

Furthermore, the method comprises a using of an algorithm on the second data set for reducing the complexity of the logical scenario, and an outputting of a third data set representing a reduced complexity logical scenario of the second data set.

The invention moreover relates to a method for providing a trained machine learning algorithm for generating a reduced complexity representation of a data set of sensor data.

The method comprises a receiving of a first training dataset having a multiplicity of classes of a logical scenario representing a vehicle action as well as a receiving of a second training data set representing a reduced complexity logical scenario of the first training data set.

In addition, the method comprises a training of the machine learning algorithm by an optimization algorithm that calculates an extreme value of a loss function for generating the reduced complexity logical representation of the first training data set.

The invention further relates to a system for generating a reduced complexity logical representation of a data set of sensor data.

The system comprises an on-board sensor for providing a first data set of sensor data of a recorded trip of an ego vehicle as well as means for transforming the first data set into a second data set having a multiplicity of classes of a logical scenario representing a vehicle action.

In addition, the system comprises a control unit for using an algorithm on the second data set for reducing the complexity of the logical scenario, wherein the control unit is equipped to output a third data set representing a reduced complexity logical scenario of the second data set.

An idea of the present invention is to achieve, by generating a reduced complexity logical representation of the data set of sensor data, an optimal abstraction and generalization of the data with which a complexity reduction or data reduction is made possible while at the same time optimally preserving the original scenario with regard to position, time, relative distances, and speed of the traffic participants.

In this way the overall situation that is visible in the data can be preserved, and it can additionally be made possible to change variables in a simple manner in order to thus vary the situation.

Varying the situation or the scenario is necessary for generating new test cases based on the data provided by the at least one on-board sensor.

The algorithm can minimize a number of classes representing a vehicle action and/or maximizes a degree of an agreement of the reduced complexity logical scenario of the third data set with the logical scenario of the second data set.

As a result, an optimum agreement of the logical scenario with the original scenario can advantageously be achieved while simultaneously achieving maximum data compression.

The transforming of the first data set into the second data set having the multiplicity of classes of the logical scenario representing a vehicle action comprises a selecting, extracting, or classifying of a change of features of the first data set representing a vehicle state.

As a result, it is advantageously possible to use one of a multiplicity of suitable methods for transforming the original scenario into a logical scenario.

The algorithm can be equipped to modify at least one value, one number, and/or one type of the multiplicity of classes representing a vehicle action. As a result, an optimum reduction in complexity of the data set can be made possible.

The multiplicity of classes representing a vehicle action includes at least one value of an acceleration process, a braking process, a change in direction and/or lane, a trip with constant speed of the ego vehicle, a lane identification, and/or a time- or location-related condition for executing a vehicle action.

As a result, a class corresponding to a vehicle action can advantageously be associated with the respective vehicle action.

The values contained by the multiplicity of classes representing a vehicle action can be time-related data, in particular a duration of a longitudinal and/or transverse acceleration of the ego vehicle, and/or location-related data, in particular a distance of the longitudinal and/or transverse acceleration of the ego vehicle.

The use of location-related data ensures here that, for example, a certain speed is achieved at a defined geographical point or an acceleration occurs at a predefined rate from a first geographical point to a second geographical point.

The location-related data can be relative data of the ego vehicle with reference to other motor vehicles and/or fixed objects, in particular a distance to the ego vehicle from other motor vehicles and/or fixed objects.

The use of such relative references as, e.g., a definition of distances relative to the ego vehicle or location-related actions such as, e.g., an initiation of a braking process starting at a certain geographical point or at a predefined distance from another vehicle has the advantage that the method permits accurate, vehicle-independent reproduction of the original scenario.

The location-related data are location-related actions, in particular a start of a vehicle action at a first geographical point, an end of the vehicle action at a second geographical point, and/or a start of the vehicle action when a predefined condition is met, in particular when a distance of other motor vehicles and/or fixed objects relative to the ego vehicle falls below or above a predefined threshold value.

The use of location-related actions has the advantage that the original scenario is accurately transferable by this means, and the deployment of different vehicles in the original scenario and the logical scenario has no effect on an accuracy of the transfer or on a degree of a data reduction or complexity reduction.

The algorithm can be used on the third data set output by the algorithm, in particular for a predefined number of optimization cycles.

As a result, it is advantageously possible to achieve a continuous optimization of the parameters of complexity reduction and data reduction of the data set.

According to further example, provision is made to calculate whether the logical scenario represented by the third data set meets a predefined exclusion criterion, in particular an occurrence of a traffic accident, a violation of a traffic regulation, and/or an intervention of a driver assistance system.

If such an exclusion criterion should be present, the complexity reduction of the second data set consequently leads to an inaccuracy that results in the exclusion criterion. As a result, the meeting of the exclusion criterion can be detected effectively.

A deviation of the third data set from the second data set can be calculated, wherein further optimization of the third data set by the algorithm is terminated and/or a third data set last output by the algorithm is discarded if the deviation lies outside a predetermined range and/or causes the exclusion criterion to be met.

As a result, a last optimization step can, for example, be undone and the optimization be continued with a preceding version of the second data set.

The calculation of the deviation of the third data set from the second data set after every optimization loop of the algorithm is carried out at predetermined intervals and/or at the end of a specified optimization cycle.

As a result, it is advantageously possible to ensure that the optimization of the second data set does not result in an exclusion criterion, in particular an occurrence of a traffic accident, a violation of a traffic regulation, and/or an intervention of a driver assistance system.

The algorithm is a machine learning algorithm, in particular an artificial neural network, a greedy algorithm, or a hill climbing algorithm.

As a result, it is advantageously possible to use one of a multiplicity of suitable algorithms for reducing the complexity of the logical scenario.

The features described herein of the method for generating a reduced complexity logical representation of a data set of sensor data are likewise applicable to the system according to the invention for generating a reduced complexity logical representation of a data set of sensor data and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a flow diagram of a method for generating a reduced complexity logical representation of a data set of sensor data according to a preferred embodiment of the invention;

FIG. 2 is a flow diagram of a method for providing a trained machine learning algorithm for generating a reduced complexity representation of a data set of sensor data according to the preferred embodiment of the invention; and

FIG. 3 is a schematic representation of a system for generating a reduced complexity logical representation of a data set of sensor data according to the preferred embodiment of the invention.

### DETAILED DESCRIPTION

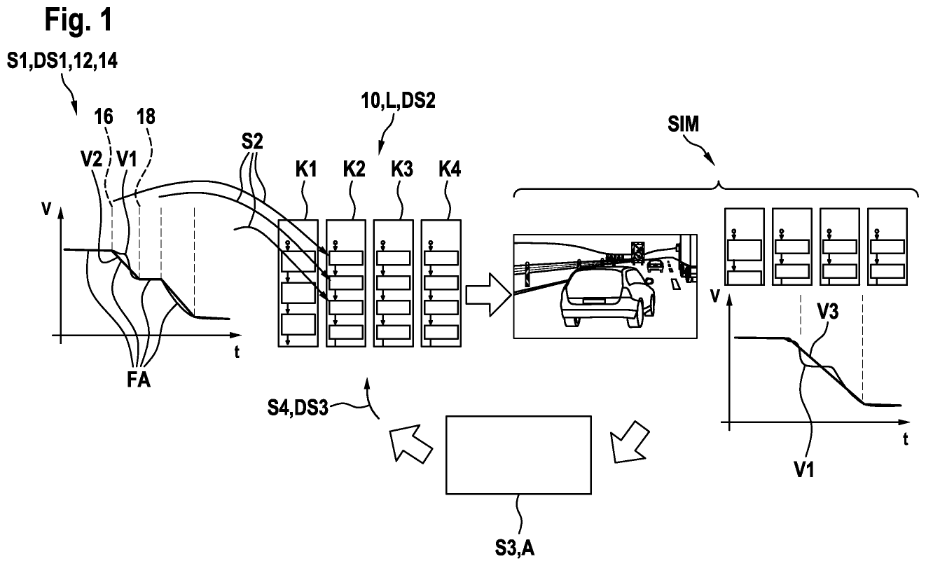

The method shown in FIG. 1 comprises a providing S1 of a first data set of sensor data of a trip of an ego vehicle 14 recorded by at least one on-board sensor.

A first speed curve V1 of the ego vehicle 14 has a number of vehicle actions FA here, for example regions with essentially constant speed as well as braking processes. The vertical axis of the depiction indicates a speed v, the horizontal axis indicates a time t.

The method additionally comprises a transforming S2 of the first data set DS1 into a second data set DS2 having a multiplicity of classes K1, K2, K3, K4 of a logical scenario L representing a vehicle action FA.

The transforming S2 of the first data set DS1 into the second data set DS2 having the multiplicity of classes K1, K2, K3, K4 of the logical scenario L representing a vehicle action FA in this case comprises a selecting, extracting, or classifying of a change of features of the first data set DS1 representing a vehicle state.

The transformed data set DS2 is represented as a second speed curve V2.

After that, a simulation step SIM optionally takes place, in which the multiplicity of classes K1, K2, K3, K4 of a logical scenario L representing a vehicle action FA are simulated using the data set DS2. Furthermore, the simulation step SIM occurs after every optimization loop of the third data set DS3.

The optimized data set DS3 has a third speed curve V3 of the ego vehicle 14. This data set substantially preserves the scenario, but has a lower complexity with respect to the first speed curve V1 and the second speed curve V2 due to a reduced number of vehicle actions FA.

The method further comprises a using S3 of an algorithm A on the second data DS2 for reducing the complexity of the logical scenario L and an outputting S4 of a third data set DS3 representing a reduced complexity logical scenario L of the second data set DS2.

The algorithm A minimizes a number of classes K1, K2, K3, K4 representing a vehicle action FA and/or maximizes a degree of an agreement of the reduced complexity logical scenario L of the third data set DS3 with the logical scenario of the second data set DS2.

The algorithm A is equipped to modify at least one value, one number, and/or one type of the multiplicity of classes K1, K2, K3, K4 representing a vehicle action FA.

The multiplicity of classes K1, K2, K3, K4 representing a vehicle action FA includes at least one value of an acceleration process, a braking process, a change in direction and/or lane, a trip with constant speed of the ego vehicle 14, a lane identification, and/or a time- or location-related condition for executing a vehicle action FA.

The values contained by the multiplicity of classes K1, K2, K3, K4 representing a vehicle action FA are time-related data, in particular a duration of a longitudinal and/or transverse acceleration of the ego vehicle 14, and/or location-related data, in particular a distance of the longitudinal and/or transverse acceleration of the ego vehicle 14.

The location-related data are relative data of the ego vehicle 14 with reference to other motor vehicles and/or fixed objects, in particular a distance to the ego vehicle 14 from other motor vehicles and/or fixed objects.

The location-related data are location-related actions, in particular a start of a vehicle action FA at a first geographical point 16, an end of the vehicle action FA at a second geographical point 18, and/or a start of the vehicle action FA when a predefined condition is met, in particular when a distance of other motor vehicles and/or fixed objects relative to the ego vehicle 14 falls below or above a predefined threshold value.

The algorithm A is used on the third data set DS3 output by the algorithm A, in particular for a predefined number of optimization cycles.

Furthermore, it is calculated whether the logical scenario L represented by the third data set DS3 meets a predefined exclusion criterion, in particular an occurrence of a traffic accident, a violation of a traffic regulation, and/or an intervention of a driver assistance system.

In addition, a deviation of the third data set DS3 from the second data set DS2 is calculated, wherein further optimization of the third data set DS3 by the algorithm A is terminated and/or a third data DS3 set last output by the algorithm A is discarded if the deviation lies outside a predetermined range and/or causes the exclusion criterion to be met.

The calculation of the deviation of the third data set DS3 from the second data set DS2 after every optimization loop of the algorithm A is carried out at predetermined intervals and/or at the end of a specified optimization cycle.

The algorithm A is preferably a machine learning algorithm, in particular an artificial neural network. Alternatively, the algorithm A can be implemented as, for example, a greedy algorithm or a hill climbing algorithm.

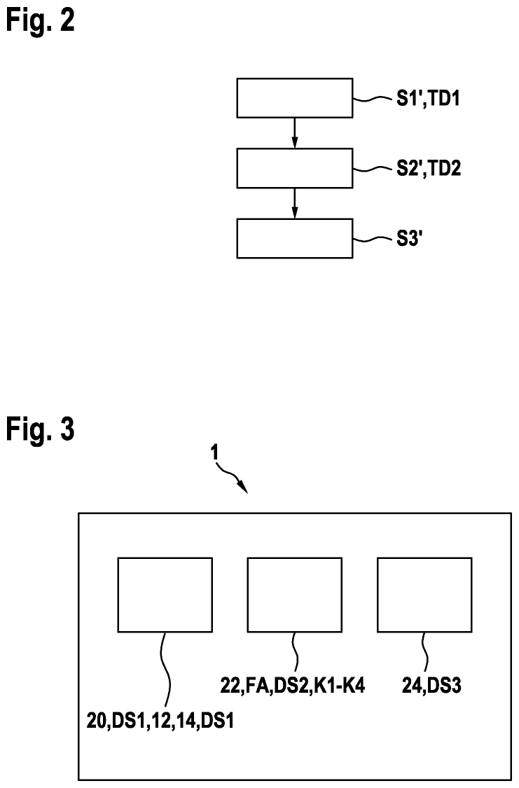

FIG. 2 shows a flow diagram of a method for providing a trained machine learning algorithm for generating a reduced complexity representation of a data set of sensor data according to the preferred embodiment of the invention.

The method comprises a receiving S1′ of a first training dataset TD1 having a multiplicity of classes K1, K2, K3, K4 of a logical scenario L representing a vehicle action FA.

Furthermore, the method comprises a receiving SZ of a second training data set TD2 representing a reduced complexity logical scenario L of the first training data set TD1.

The method additionally comprises a training S3′ of the machine learning algorithm A by an optimization algorithm that calculates an extreme value of a loss function for generating the reduced complexity logical representation 10 of the first training data set TD1.

FIG. 3 shows a schematic representation of a system for generating a reduced complexity logical representation of a data set of sensor data according to the preferred embodiment of the invention.

The system comprises an on-board sensor 12 for providing a first data set DS1 of sensor data of a trip of an ego vehicle 14 recorded by at least one on-board sensor 12.

The system further comprises means 22 for transforming the first data set DS1 into a second data set DS2 having a multiplicity of classes K1, K2, K3, K4 of a logical scenario L representing a vehicle action FA.

In addition, the system comprises a control unit 24 for using S3 an algorithm A on the second data DS2 for reducing the complexity of the logical scenario L, wherein the control unit 24 is equipped to output a third data set DS3 representing a reduced complexity logical scenario L of the second data set DS2.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for generating a reduced complexity logical representation of a data set of sensor data, the method comprising:
providing a first data set of sensor data of a trip of an ego vehicle recorded by at least one on-board sensor;
transforming the first data set into a second data set having at least two classes of a logical scenario representing a vehicle action;
using an algorithm on the second data set to reduce the complexity of the logical scenario; and
outputting a third data set representing a reduced complexity logical scenario of the second data set.

2. The method according to claim 1, wherein the algorithm minimizes a number of classes representing a vehicle action and/or maximizes a degree of an agreement of the reduced complexity logical scenario of the third data set with the logical scenario of the second data set.

3. The method according to claim 1, wherein the transforming of the first data set into the second data set having the at least two classes of the logical scenario representing a vehicle action comprises a selecting, extracting, or classifying of a change of features of the first data set representing a vehicle state.

4. The method according to claim 1, wherein the algorithm is equipped to modify at least one value, one number, and/or one type of the multiplicity of classes representing a vehicle action.

5. The method according to claim 1, wherein the at least two classes representing a vehicle action includes at least one value of an acceleration process, a braking process, a change in direction and/or lane, a trip with constant speed of the ego vehicle, a lane identification, and/or a time- or location-related condition for executing a vehicle action.

6. The method according to claim 1, wherein the values contained by the at least two classes representing a vehicle action are time-related data, in particular a duration of a longitudinal and/or transverse acceleration of the ego vehicle, and/or location-related data or a distance of the longitudinal, and/or transverse acceleration of the ego vehicle.

7. The method according to claim 6, wherein the location-related data are relative data of the ego vehicle with reference to other motor vehicles and/or fixed objects or a distance to the ego vehicle from other motor vehicles and/or fixed objects.

8. The method according to claim 7, wherein the location-related data are location-related actions, in particular a start of a vehicle action at a first geographical point, an end of the vehicle action at a second geographical point, and/or a start of the vehicle action when a predefined condition is met or when a distance of other motor vehicles and/or fixed objects relative to the ego vehicle falls below or above a predefined threshold value.

9. The method according to claim 1, wherein the algorithm is used on the third data set output by the algorithm or for a predefined number of optimization cycles.

10. The method according to claim 1, wherein it is calculated whether the logical scenario represented by the third data set meets a predefined exclusion criterion, an occurrence of a traffic accident, a violation of a traffic regulation, and/or an intervention of a driver assistance system.

11. The method according to claim 10, wherein a deviation of the third data set from the second data set is calculated, and wherein further optimization of the third data set by the algorithm is terminated and/or a third data set last output by the algorithm is discarded if the deviation lies outside a predetermined range and/or causes the exclusion criterion to be met.

12. The method according to claim 11, wherein the calculation of the deviation of the third data set from the second data set after every optimization loop of the algorithm is carried out at predetermined intervals and/or at the end of a specified optimization cycle.

13. The method according to claim 1, wherein the algorithm is a machine learning algorithm, an artificial neural network, a greedy algorithm, or a hill climbing algorithm.

14. A method for providing a trained machine learning algorithm for generating a reduced complexity representation of a data set of sensor data, the method comprising:
receiving a first training dataset having at least two classes of a logical scenario representing a vehicle action;
receiving a second training data set representing a reduced complexity logical scenario of the first training data set; and
training the machine learning algorithm by an optimization algorithm that calculates an extreme value of a loss function for generating the reduced complexity logical representation of the first training data set.

15. A system for generating a reduced complexity logical representation of a data set of sensor data, the system comprising:
at least one on-board sensor to provide a first data set of sensor data of a recorded trip of an ego vehicle;
transformer to transform the first data set into a second data set having at least two classes of a logical scenario representing a vehicle action; and
a control unit to use an algorithm on the second data set to reduce the complexity of the logical scenario,
wherein the control unit is equipped to output a third data set representing a reduced complexity logical scenario of the second data set.
